(19) United States
(12) Patent Application Publication
(10) Pub. No.: US 2007/0023333 A1
(43) Pub. Date: Feb. 1, 2007

(54) Missing element indicator

(75) Inventors: Bijan Mouhebaty, Westlake Village, CA (US); Jack Torosian, North Hollywood, CA (US); Kanwar Suri, Northridge, CA (US); Sandra Grossman, Camarillo, CA (US)

Correspondence Address: BRINKS HOFER GILSON & LIONE, P.O. BOX 10395, CHICAGO, IL, 60610, US

(73) Assignee: PTI TECHNOLOGIES, INC., Oxnard, CA (US)

(21) Appl. No.: 11/194,032

(22) Filed: Jul. 29, 2005

(51) Int. Cl. B01D 35/14

(52) U.S. Cl. 210/91; 210/435; 116/204; 116/281; 116/283

(57) ABSTRACT

An indicator device utilizes a pair of magnets to provide a missing-element indication. The indicator may be installed within a filter assembly such that, when a filter element is present, it urges a piston disposed towards the top of the indicator and one of the magnets to slide axially inwards through the indicator's housing and attract the second magnet. The latter then causes a button disposed at the bottom of the indicator to move axially inwards, such that no missing-element indication is provided. When the filter element is removed or is missing, the piston moves axially outwardly, thereby either reducing the force of attraction, or increasing the repulsive force, between the two magnets and causing the button to pop out through the indicator's bottom end and provide visual indication of a missing-element condition. The indication may also be provided as a remote electrical signal, which may be transmitted wirelessly.

### FIELD OF INVENTION

The present invention generally relates to fluid filtration. More particularly, the present invention relates to indicators for providing a warning when a filter element of a filter assembly is missing, of an incorrect size, or improperly installed, and to filter assemblies incorporating such indicators.

### BACKGROUND

Fluid cleanliness is an important factor in the health of a fluidic/hydraulic system. Engine oil lubrication systems, for example, which are typical of many fluidic systems, frequently include a filter assembly for removing damaging particles from the lubricating oil utilized in the system. Mechanical wear within the engine, the outside environment, and contaminants accidentally introduced during normal servicing provide a source of large particles which may plug lubricating nozzles or severely damage parts and create excessive wear on surfaces that may rely on a thin film of the lubricating oil for protection.

Clearly, the level of undesirable contaminants in the fluid affects not only the quality of system performance, but also the useful life of substantially all of the working components within the system. All moving components in contact with the fluid are vulnerable to wear and, therefore, the resultant premature failure, if such contaminants are not removed from the system. Consequently, proper cleaning of the fluid to remove undesirable contaminants can significantly lengthen the life of the system components, as well as reduce maintenance and its attendant costs. Further, effective cleanliness control can result in significant improvements in the overall reliability and performance of the system.

Filter assemblies, or modules, have been used for this purpose in a variety of applications and fluidic environments. In typical filter assemblies, a filter element is encased within a filter body, or casing (e.g., a filter bowl). One or more filter manifolds may be attached to the filter body to feed unfiltered medium to the upstream side of the filter element (e.g., where the filter element is cylindrical, the outside of the filter element). As the medium passes through the membrane material to the downstream side of the filter element, contaminants are removed from the medium. Filtered medium is then collected from the downstream side of the filter element (e.g., where the filter element is cylindrical, the inside of the filter element).

During the filter element's service life, an increasing amount of removed contaminant will collect on one side of the filter element, which causes the pressure difference between the upstream and downstream sides of the filter element to increase, thereby lowering the filtration efficiency of the filter element. If the differential pressure exceeds a certain pre-determined value that is dependent upon the filter element material, design, etc., the filter element may be damaged. Additionally, at high differential pressures, particle breakthrough (i.e., contaminant particles passing through the pores in the filter element) may occur. Timely cleaning or replacement of the filter element is therefore of utmost importance.

To this end, in existing filter assemblies, the filter head may contain pressure transducers, temperature detectors, or other similar means to measure characteristics of fluid flow and filter performance. These components are used to sense the differential pressure across the filter element to determine whether the filter element is sufficiently clogged with contaminant removed from the fluid flow to require replacement. Thus, once the differential pressure across the filter element reaches the pre-determined threshold, an indication may be provided (e.g., by causing a part to pop up out of the exterior of the filter head) to signal the need to replace the filter element.

Still, such devices only signal the need for replacement of the filter element. However, once a filter element has been removed from the filter assembly, it must be ensured that a replacement filter, of the correct size/configuration, is properly re-installed into the filter assembly prior to placing the assembly back into service. In aircraft applications, for example, on numerous prior occasions, maintenance personnel have failed to install a filter element into the filter assembly after the used filter element was removed. With no provisions for detecting and indicating a missing-element condition, the aircraft was then placed back into service and flown without proper filtration, thereby causing severe damage to down-stream components.

There is therefore a need for a means of detecting situations in which a filter element is absent, of an incorrect size, improperly installed, etc., and providing a warning signal to alert personnel prior to re-deployment of the filter assembly.

### BRIEF DESCRIPTION OF THE DRAWINGS

FIG. 1 shows an indicator according to an embodiment of the present invention;

FIG. 2 shows an indicator according to an alternative embodiment of the present invention;

FIG. 3 shows the indicator of FIG. 1 installed in a filter bowl according to an embodiment of the present invention;

FIG. 4 shows a filter assembly according to an embodiment of the present invention, with a filter element present within the bowl shown in FIG. 3;

FIG. 5 shows an embodiment of the present invention providing for remote indication; and

FIG. 6 shows an alternative embodiment of the present invention providing for remote indication.

### DETAILED DESCRIPTION

The present invention addresses the above-mentioned shortcomings by way of indicator devices, and filter assemblies incorporating such devices, that provide a visual and/or electrical (remote) indication of a missing filter element. It is noted that, in the instant application, the term “missing” is used to refer generally to situations where no filter element is installed, or a filter element of an incorrect size is installed, or a filter element is mis-aligned/improperly installed, etc. In addition, although specific situations may be referred to herein, such references are made by way of example only, and the present invention is applicable to all aerospace/aircraft, marine, and land-based filtration systems involving oil, fuel, water, and/or other fluid filtration.

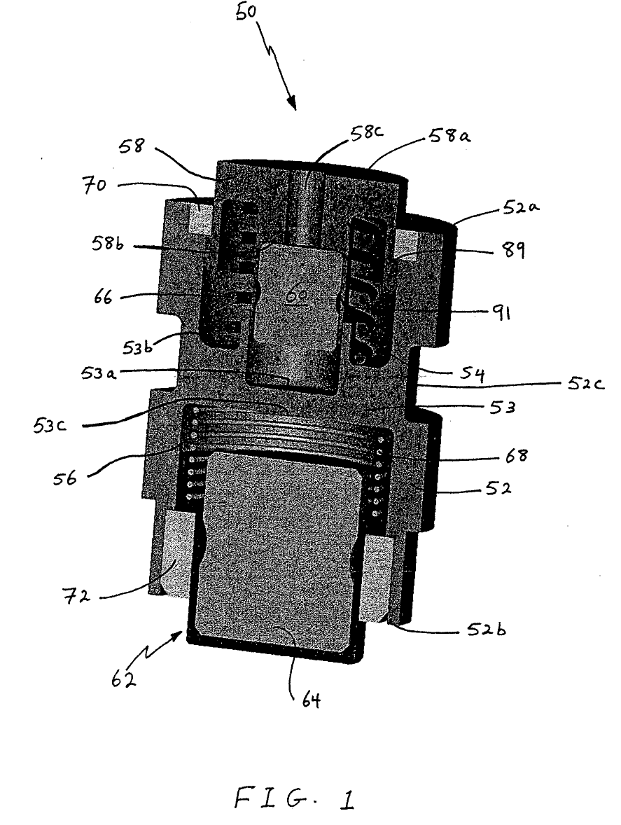

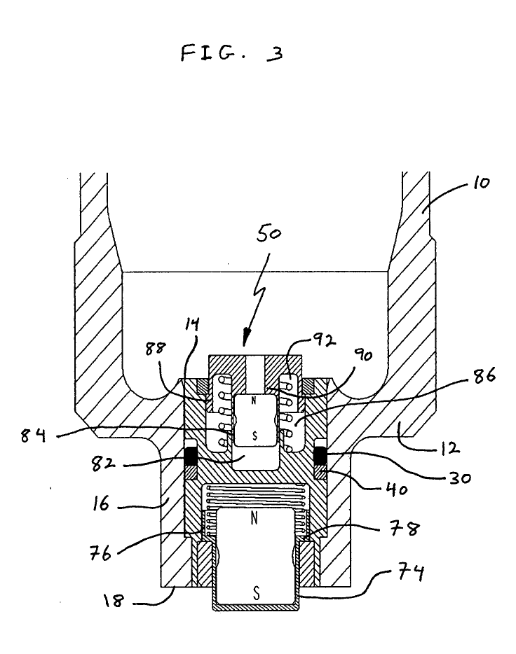

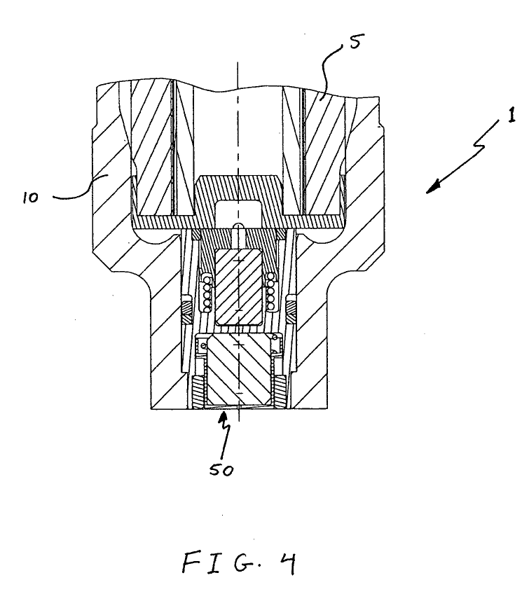

FIG. 1 shows an indicator device 50 according to an embodiment of the present invention. As shown in FIGS. 3 and 4, the indicator device may generally be adapted for use with a filter assembly 1, including a filter element 5 and a bowl (or casing) 10 that houses the filter element 5.

In a preferred embodiment, the indicator device 50 has a generally cylindrical configuration, and includes a housing 52 having a top end 52a and a bottom end 52b. Towards its upper portion, the housing 52 includes a first passage 54 that is separated from a second passage 56 by a solid transverse section 53, where the wall of each of the passages 54, 56 is defined by a respective portion of the radially-inner surface of the housing 52. Thus, the first passage 54 extends from the solid transverse section 53 to the top end 52a of the housing 52, while the second passage 56 extends from the solid transverse section 53 to the bottom end 52b of the housing 52.

As shown in FIGS. 1 and 3, the first passage 54 comprises a radially central compartment 82 and an annular compartment 86. The radially central compartment 82 includes an annular wall 84 that extends axially from a point 53a on the solid transverse section 53 towards the housing's top end 52a. In a preferred embodiment, the annular wall 84 extends only part-way between the point 53a and the housing's top end 52a. The annular compartment 86 is then defined as the area between the wall of the first passage 54 (i.e., the radially-inner surface of the housing 52) and the annular wall 84, and extends from a point 53b on the solid transverse section 53 towards the housing's top end 52a.

The indicator 50 includes a piston 58 that is disposed so as to slide axially within the first passage 54, and a button 62 that is disposed so as to slide axially within the second passage 56. In embodiments of the invention, the piston 58 is generally T-shaped, including an upper end 58a that may form the horizontal portion of the “T”. The T-shaped piston 58 also includes a (unitary) central vertical portion 90, which extends axially downwards a distance from the upper end 58a, and then becomes hollow, with the hollow portion having an annular wall 91 and a top end 58b. As shown in FIGS. 1 and 3, the annular wall 91 is configured to have a smaller diameter than the annular wall 84 of the radially-central compartment 82 such that the annular wall 84 functions as a guide for the sliding movement of the annular wall 91 of the central vertical portion 90.

The upper end 58a of the piston 58 is also unitary with an annular outer wall 88 that extends axially downwards from the upper end's periphery and is disposed such that its sliding movement is guided by the wall of the first passage 54. In addition, a (second) annular compartment 92 is formed between the central vertical portion 90 and the annular outer wall 88, and is bounded on top by the underside of the piston's upper end 58a. Preferably, the piston 58 is retained in place by an upper annular cap (or retainer) 70 that is disposed between the annular outer wall 88 and the wall of the first passage 54. In this regard, the annular outer wall 88 may have a lip 89 that abuts the upper annular cap 70 when the piston 58 is fully extended outwards.

The indicator 50 also includes a first magnet 60, which may be, e.g., a pin magnet. As shown in FIGS. 1 and 4, in one preferred embodiment, around its periphery, the first magnet 60 is in contact with the wall 91 of the piston's central vertical portion 90 and, at its top, the first magnet 60 is in contact with the top end 58b of the hollow portion of the piston's central vertical portion 90. In addition, a first biasing means, such as, e.g., a coil spring (or other similar means known in the art for providing a biasing force for the piston 58) is disposed generally around the first magnet 60, the annular wall 84, and the annular wall 91, such that it lies between the underside of the piston's upper end 58a (i.e., the top end of the annular compartment 92) and the bottom of the annular compartment 86 (i.e., the point 53b on the solid transverse section 53).

In embodiments of the invention, the magnet 60 is epoxy bonded to the top end 58b. In addition, the piston 58 may include a longitudinal bore 58c that allows for bleeding of air during the epoxy bonding process. The bore 58c also helps to reduce the overall weight of the indicator 50.

As shown in the embodiment of FIGS. 1 and 3, the button 62 is a unitary member that has a vertical, generally U-shaped lower portion 74, and an upper portion that comprises: (1) a vertical annular wall 76 having a larger diameter than the lower portion 74; and (2) an annular horizontal member (or flange) 78 that connects (i.e., provides the transition between) the lower portion 74 to the annular wall 76. The annular wall 76 is configured such that it is received, and its sliding movement is guided by, the wall of the second passage 56. In addition, the button 62 is retained in place by a lower annular cap 72 that is disposed between the U-shaped lower portion 74 and the wall of the second passage 56.

In embodiments of the invention, a second magnet 64, such as, e.g., a pin magnet, lies within the U-shaped lower portion 74 and extends into the upper portion of the button 62. In the embodiment shown in FIGS. 1 and 3, the second magnet 64 generally abuts the inner surfaces of the button's lower portion 74, but has a smaller diameter than the button's vertical annular wall 76. This allows for a second biasing means, such as, e.g., a coil spring (or other similar means known in the art for providing a biasing force for the button 62) to be disposed generally around (an upper portion of) the second magnet 64. In this embodiment, the second biasing means 68 lies between the flange 78 and the underside 53c of the solid transverse section 53 (i.e., the upper, closed end of the second passage 56), and urges the flange 78 to abut the lower annular cap 72 when the button 62 is fully extended outwards.

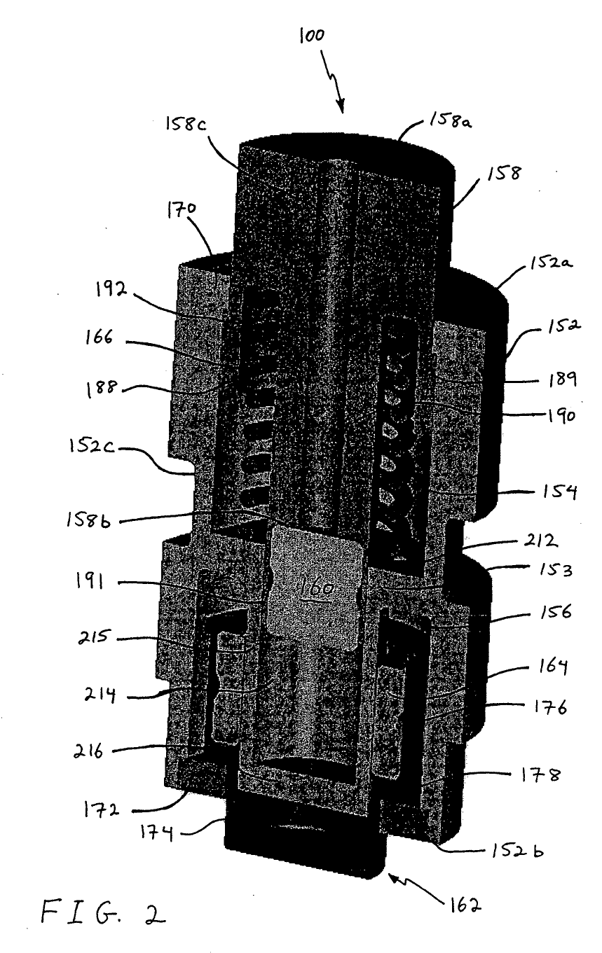

FIG. 2 shows another preferred embodiment in which the indicator 100 has a housing 152 having a top end 152a and a bottom end 152b, a first passage 154, and an annular compartment 156. The first passage 154 is separated from the annular compartment 156 by a semi-closed transverse section, or base, 153. As with the embodiment of FIG. 1, the walls of the first passage 154 and the annular compartment 156 are defined by a respective portion of the radially-inner surface of the housing 152. Thus, the first passage 154 extends from the semi-solid base 153 to the housing's top end 152a, while the annular compartment 156 extends from the semi-closed base 153 to the housing's bottom end 152b. As shown in FIG. 2, the indicator 100 also includes a second passage 214 which is defined by an axial annular wall 215 that extends from a central opening 212 in the semi-closed base 153 to a solid base 216 adjacent the housing's bottom end 152b.

In a preferred embodiment, a piston 158 is disposed so as to slide axially within the first passage 154. As with other embodiments of the present invention, the piston 158 is generally T-shaped, including an upper end 158a that may form the horizontal portion of the “T”. The T-shaped piston 158 also includes a (unitary) central vertical portion 190, which extends axially downwards from the upper end 158a, and then becomes hollow, with the hollow portion having an annular wall 191 and a top end 58b. As shown in FIG. 2, the annular wall 191 is configured to have a smaller diameter than the annular wall 215 of the second passage 214 such that the annular wall 215 functions as a guide for the sliding movement of the annular wall 191 of the central vertical portion 190.

The upper end 158a of the piston 158 is also unitary with an annular outer wall 188 that extends axially downwards from the upper end's periphery and is disposed such that its sliding movement is guided by the wall of the first passage 154. In addition, a (second) annular compartment 192 is formed between the central vertical portion 190 and the annular outer wall 188, and is bounded on top by the underside of the piston's upper end 158a. Preferably, the piston 158 is retained in place by an upper annular cap (or retainer) 170 that is disposed between the annular outer wall 188 and the wall of the first passage 154. In this regard, the annular outer wall 188 may have a lip 189 that abuts the upper annular cap 170 when the piston 158 is fully extended outwards.

The indicator 100 also includes a first magnet 160, which may be, e.g., a pin magnet. As shown in FIG. 2, in one preferred embodiment, around its periphery, the first magnet 160 is in contact with the annular wall 191 of the piston's central vertical portion 190 and, at its top, the first magnet 160 is in contact with the top end 158b of the hollow portion of the piston's central vertical portion 190. In addition, a biasing means, such as, e.g., a coil spring (or other similar means known in the art for providing a biasing force for the piston 158) is disposed generally around the piston's central vertical portion 190, such that it lies between the semi-closed base 153 and the underside of the piston's upper end 158a (i.e., the top end of the annular compartment 192).

In embodiments of the invention, the magnet 160 is epoxy bonded to the top end 158b. In addition, the piston 158 may include a longitudinal bore 158c that allows for bleeding of air during the epoxy bonding process. The bore 158c also helps to reduce the overall weight of the indicator 100.

The indicator 100 also includes a button 162 that is disposed so as to slide axially within the annular compartment 156. As shown FIG. 2, the button 162 is a unitary member that has a vertical, generally U-shaped lower portion 174, and an upper portion that comprises: (1) a vertical annular wall 176 having a larger diameter than the lower portion 174; and (2) an annular horizontal member (or flange) 178 that connects (i.e., provides the transition between) the lower portion 174 to the annular wall 176. The annular wall 176 is configured such that it may be received, and its sliding movement guided by, the wall of the annular compartment 156.

In the embodiment of FIG. 2, a second magnet 164, which is preferably a ring magnet, is disposed within the button's upper portion such that it lies on the flange 178, between the button's vertical annular wall 176 and the annular wall 215 of the second passage 214. In addition, the button 162 is retained in place by a lower annular cap 172 that is disposed between the U-shaped lower portion 174 and the wall of the annular compartment 156.

FIGS. 3 and 4 show a bowl 10 in which an indicator in accordance with the present invention may be installed. It is noted that, while the device shown in these figures corresponds to the indicator 50 depicted in FIG. 1, the principles discussed hereinbelow apply equally to the indicator 100 depicted in FIG. 2.

With reference to FIGS. 1, 3, and 4, the bowl 10 includes a base 12 which has a central opening 14. Unitary with the bowl 10, an annular wall 16 extends vertically downwards from the central opening 14 and is configured to receive therein the indicator 50. Thus, when installed, the radially outer surface of the indicator's housing 52 abuts the radially inner surface of the annular wall 16. In addition, an annular seal 30, and/or a Teflon ring 40, may be disposed between the radial groove 52c, 152c (see FIGS. 1 and 2) of the indicator housing 52, 152 and the radially inner surface of the annular wall 16.

In practice, the devices 50, 100 are used to indicate a missing filter element, where the term “missing” refers generally to situations where no filter element is installed, or a filter element of an incorrect size is installed, or a filter element is mis-aligned/improperly installed, etc. As shown in FIG. 3, the indicator 50, 100 is installed within the annular wall 16 of the bowl's base 12 such that the bottom end 52b, 152b of the indicator's housing is substantially flush with the bottom end 18 of the annular wall 16.

When indicator 50 is used in the filter assembly 1, the first magnet 60 and second magnet 64 are positioned such that they face one another with respective opposite poles. Thus, when a filter element 5 of correct size/shape is properly installed within the bowl 10, the filter element 5 rests on the upper end 58a of the piston 58. The weight of the filter element 5 then causes the piston assembly (i.e., the piston 58 and the first magnet 60) to slide downwards, i.e., inwards. Given the polar configuration of the two magnets 60, 64, the inward motion of the piston assembly creates a magnetic force that overcomes the spring force of the second spring 68, thereby attracting the button assembly (i.e., the button 62 and the second magnet 64) to move upwards, i.e., inwards. In this way, when a filter element 5 is properly installed, the button is pulled all the way in such that it is substantially flush with the bottom end 18 of the annular wall 16 and the bottom end 52b of the housing 52 (see FIG. 4).

However, when the filter element 5 is missing (see, e.g., FIG. 3), the first spring 66 pushes the piston assembly outwards, thereby reducing the force of attraction between the two magnets 60, 64. This, in turn, allows the second spring 68 to push the button assembly outwards, thereby providing a visual signal that indicates a missing filter element. In embodiments of the invention, the U-shaped lower portion 74 of the button 62, or a visible section thereof, may be colored (e.g., red) to enhance visibility.

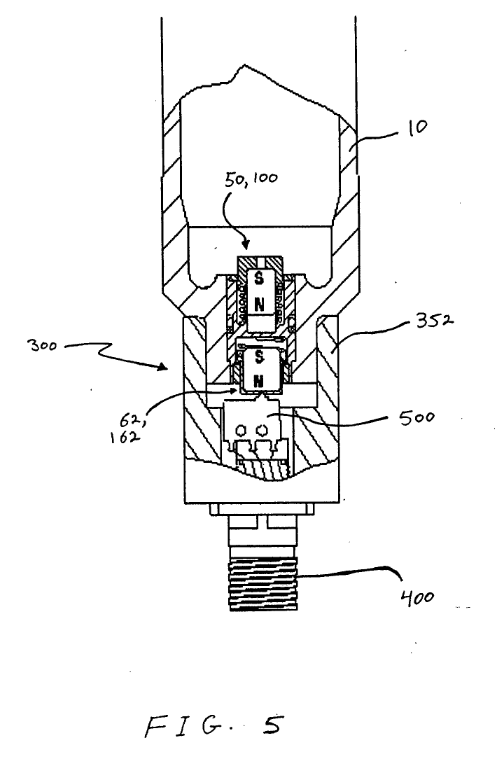

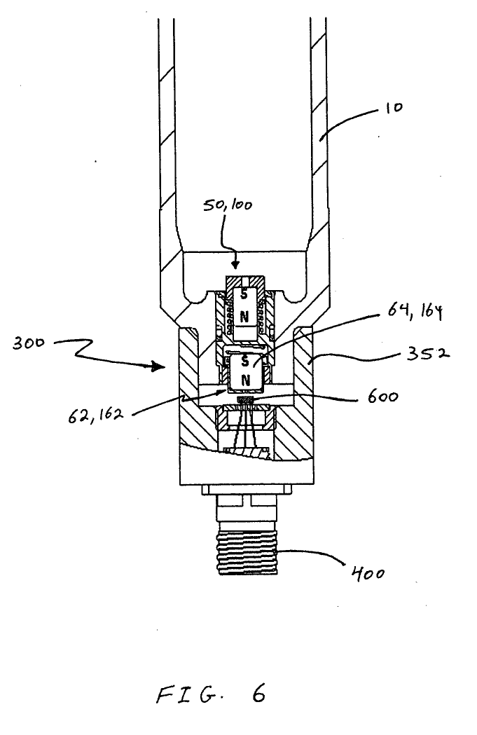

In embodiments of the invention, the visual signal/warning may be replaced by, and/or supplemented with, an electrical indication. Thus, in one embodiment, means may be provided for generating an electrical signal to indicate a missing filter element. See, e.g., FIGS. 5 and 6. For example, a micro-switch, an electrical connector, and an electrical circuit may be provided as known in the art, where the button 62 is configured to activate the micro-switch by pushing on the micro-switch's plunger, thereby opening or closing the electrical circuit which, in turn, will generate an electrical signal. Once generated, the signal may be transmitted to provide a missing-filter-element indication at a location remote from the filter assembly 1. In addition, such transmission of the signal may be performed wirelessly by means known in the art.

FIGS. 5 and 6 show two embodiments incorporating means for remote electrical indication. It is again noted that, while the indicator device shown in these figures corresponds to the indicator 50 depicted generally in FIG. 1, the principles discussed herein apply equally to the indicator 100 depicted generally in FIG. 2.

As shown in FIG. 5, the bowl 10 may be connected to a remote sensing assembly 300 having a housing 352 and including an electrical connector 400 and a micro-switch 500. The indicator 50 (or 100) is connected to the bowl 10 as described above, such that, when the filter element 5 is missing, the button assembly is urged outwards. As shown, the outwards extension of the button 62 (or 162) provides a load that pushes on the micro-switch's plunger, thereby closing (or opening, if wired in reverse) an electrical circuit. On the other hand, when the filter element 5 is properly installed, the button 62 (or 162) is retracted inwards, such that no load is exerted on the micro-switch plunger, and the electrical circuit is opened (or closed, if wired in reverse). A corresponding signal may then be transmitted through the electrical connector 400 (or pigtail wire) for remote indication.

FIG. 6 shows an alternative embodiment in which the micro-switch 500 is replaced by a Hall Effect sensor 600. As is known, the Hall Effect sensor 600 actuates when situated within the proximity of a magnetic field. Thus, in this embodiment, the sensor 600 is disposed within the sensor assembly 300 such that, when the filter element 5 is missing and the button assembly extends outwards, the magnetic field of the second magnet 64 (or 164) is situated within proximity of the sensor 600, thereby actuating the sensor. This, in turn, causes an electrical circuit to close (or open, if wired in reverse), thereby generating an electrical signal that is transmitted via, e.g., the electrical connector 400, pigtail leads, etc.

When, on the other hand, the filter element 5 is properly installed, the button 62, 162 is retracted inwards. As a result, the magnet 64, 164 (and corresponding magnetic field) is no longer within actuating proximity of the Hall Effect sensor 600, which causes the sensor 600 to deactivate (e.g., open the electrical circuit) and indicate an “off” condition.

It is noted that other means for generating an electrical signal may also be used. For example, in the embodiment of FIG. 6, the Hall Effect sensor 600 may be replaced by a Reed switch. As is known, a typical Reed switch may consist of two (flat) ferromagnetic reeds sealed within a glass capsule such that, in the presence of a magnetic field (such as, e.g., the magnetic field of the second magnet 64 or 164), the reeds are attracted to each other and close to complete the magnetic and electric circuit. In addition, with the micro-switch, the Hall Effect sensor, the Reed switch, etc., the actual mechanism for remote indication may be attached to existing visual Maintenance Engineering Inspection (MEI) equipment.

As mentioned previously, the indicator 100 shown in FIG. 2 may also be used in the filter assembly 1. Here, as before, when a filter element 5 of correct size/shape is properly installed within the bowl 10, the filter element 5 rests on the upper end 158a of the piston 158, and the weight of the filter element 5 causes the piston assembly to slide downwards (i.e., inwards). However, now, the functionality of the second (pin) magnet 64 and the second spring 68 is essentially provided by the second (ring) magnet 164. Thus, as the piston assembly moves inwards, a magnetic force is created that attracts the ring magnet 164 and causes the button assembly to also move inwards, thereby providing no indication. Once again, in this way, when a filter element 5 is properly installed, the button is pulled all the way in such that it is substantially flush with the bottom end 18 of the annular wall 16 and the bottom end 152b of the housing 152.

However, when the filter element 5 is missing, the spring 166 pushes the piston assembly outwards, thereby reducing the force of attraction between the two magnets 160, 164, and positioning them to repulse one another. This repulsion, in turn, urges the button assembly outwards, thereby providing a visual signal that indicates a missing filter element.

As with the indicator 50, in this embodiment, the U-shaped lower portion 174 of the button 162, or a visible section thereof, may be colored (e.g., red) to enhance visibility. In addition, the visual signal/warning may be replaced by, and/or supplemented with, an electrical signal for (normal and wireless) remote indication as described previously.

While the description above refers to particular embodiments of the present invention (the presently disclosed embodiments are to be considered in all respects as illustrative and not restrictive), it will be understood that many modifications may be made without departing from the spirit thereof. The accompanying claims are intended to cover such modifications as would fall within the true scope and spirit of the present invention. All changes that come within the meaning, and range of equivalency, of the claims are intended to be embraced therein.

What is claimed is:

1. A device for indicating a missing filter element in a filter assembly, the device comprising:
(a) a housing having a top end, a bottom end, a first passage extending axially from said top end toward said bottom end, and a second passage extending axially from said bottom end toward said top end;
(b) a piston slidably disposed through said top end of the housing, the piston being configured to move axially through said first passage and having an upper end for selectively receiving a filter element thereon;
(c) a first magnet disposed axially adjacent said piston and within said first passage;
(d) a button slidably disposed through said bottom end of the housing, the button being configured to move axially through said second passage; and
(e) a second magnet disposed axially adjacent said button, wherein the first and second magnets face one another with respective opposite poles such that, when a filter element rests on the piston's upper end, the piston and first magnet slide axially inside said first passage, thus attracting the second magnet and button axially inside said second passage, and when the filter element is removed, the piston moves axially outwardly through the housing's top end and the button pops out through the housing's bottom end, thereby indicating a missing filter element.

2. The device of claim 1, further including first biasing means disposed axially below said upper end of the piston, the biasing means being configured to urge the piston out through the housing's top end when the filter element is missing.

3. The device of claim 2, wherein said biasing means is a coil spring.

4. The device of claim 1, further including a second biasing means disposed axially within said second passage so as to urge the button out through the housing's bottom end when the filter element is missing.

5. The device of claim 4, wherein said second biasing means is a coil spring.

6. The device of claim 1, wherein said first and second magnets are pin magnets.

7. The device of claim 1, wherein the piston and button are generally cylindrical, and the device further includes an upper annular cap disposed between a radially outer surface of the piston and a wall of the first passage, and a lower annular cap disposed between a radially outer surface of the button and a wall of the second passage.

8. The device of claim 7, wherein the button has a vertical U-shaped lower portion that is unitary with an upper portion, said second magnet being disposed within said lower portion and extending into said upper portion, and said lower annular cap being disposed between the lower portion's outer surface and said wall of the second passage.

9. The device of claim 8, wherein the button's upper portion includes a vertical annular wall that has a larger diameter than the button's lower portion and is joined to the lower portion by an annular horizontal member, said horizontal member forming a flange that accepts a biasing means on its upper side, and is adjacent said lower annular cap on its underside when the button extends through the housing's bottom end.

10. The device of claim 9, wherein the biasing means is a coil spring that is disposed between said flange and an upper, closed end of the second passage, said coil spring being disposed around an upper portion of the second magnet.

11. The device of claim 7, wherein the first passage includes a radially central compartment having a first axially-extending annular wall, said first annular wall and the wall of the first passage defining therebetween a first annular compartment surrounding said central compartment, and said central compartment being configured to receive said first magnet.

12. The device of claim 11, wherein the piston is T-shaped, said upper end of the piston forms the horizontal portion of the T and has a second annular outer wall that extends vertically downwards from the periphery of said horizontal portion, and the second annular outer wall and a central vertical portion of the T-shaped piston define a second annular compartment therebetween, the device further including a coil spring that is disposed around said first magnet and between a bottom of said first annular compartment and a top of said second annular compartment.

13. The device of claim 12, wherein the central vertical portion of the T-shaped piston rests at least partially atop said first magnet, and said upper annular cap is disposed between a radially-outer surface of said second annular outer wall and the wall of the first passage.

14. The device of claim 1, further including means for providing an electrical signal to indicate a missing filter element.

15. The device of claim 14, wherein said means includes a member selected from the group consisting of a micro-switch, a Hall Effect sensor, and a Reed switch.

16. The device of claim 14, wherein said electrical signal is transmitted to provide a missing-filter-element indication at a location remote from said device.

17. The device of claim 16, wherein the electrical signal is transmitted wirelessly.

18. The device of claim 1, wherein the button is colored to enhance visual indication of a missing filter element.

19. A device for indicating a missing filter element in a filter assembly, the device comprising:
(a) a cylindrical housing having a top end, a bottom end, a first passage extending axially inwards from said top end and having a semi-closed base that defines a central opening therethrough, and a second passage having an annular wall that extends axially from said opening to a solid base adjacent said housing's bottom end, said annular wall and a wall of the housing below said semi-closed base defining an annular compartment therebetween;
(b) a piston slidably disposed through said top end of the housing, the piston being configured to move axially through said first passage and having an upper end for selectively receiving a filter element thereon;
(c) a first magnet disposed axially adjacent said piston and configured to move through said second passage;
(d) a button slidably disposed through said bottom end of the housing, the button being configured to move axially through said annular compartment; and
(e) a second magnet disposed adjacent said button such that, when a filter element rests on the piston's upper end, the piston urges the first magnet axially through said second passage, thus attracting the second magnet and button axially inside said annular compartment, and when the filter element is removed, the piston moves axially outwardly through the housing's top end and the button pops out through the housing's bottom end, thereby indicating a missing filter element.

20. The device of claim 19, wherein the first magnet is a pin magnet and the second magnet is a ring magnet that is disposed such that, when the pin magnet moves towards the housing's top end, the first and second magnets repulse one another, thereby causing the button to pop out through the housing's bottom end.

21. The device of claim 19, further including a biasing means disposed axially below said upper end of the piston, the biasing means being configured to urge the piston out through the housing's top end when the filter element is missing.

22. The device of claim 21, wherein said biasing means is a coil spring.

23. The device of claim 19, further including an upper annular cap disposed between a radially-outer surface of the piston and a radially-inner surface of the first passage, and a lower annular cap disposed between a radially-outer surface of the button and a radially-inner surface of the compartment's outer wall.

24. The device of claim 23, wherein the button has a vertical U-shaped lower portion that is unitary with an upper portion, and the button's upper portion includes a vertical annular wall that has a larger diameter than the button's lower portion and is joined to the lower portion by an annular horizontal member, said horizontal member forming a flange that accepts said second magnet on its upper side and is adjacent said lower annular cap on its underside when the filter element is missing.

25. The device of claim 24, wherein the second magnet is a ring magnet that is disposed on said flange's upper side between the annular wall of the second passage and the vertical annular wall of the button's upper portion.

26. The device of claim 23, wherein the piston is T-shape, said upper end of the piston forms the horizontal portion of the T and has a second annular outer wall that extends vertically downwards from the periphery of said horizontal portion, and the device further includes a coil spring that is disposed around said central vertical portion of the T-shaped piston and between the semi-closed base and a bottom of said piston's upper end.

27. The device of claim 26, wherein the central vertical portion of the T-shaped piston rests at least partially atop said first magnet, and said upper annular cap is disposed between a radially-outer surface of said second annular outer wall and said radially inner surface of the first passage.

28. The device of claim 19, further including means for providing an electrical signal to indicate that the filter element is missing.

29. The device of claim 28, wherein said means includes a member selected from the group consisting of a micro-switch, a Hall Effect sensor, and a Reed switch.

30. The device of claim 28, wherein said electrical signal is transmitted to provide a missing-filter-element indication at a location remote from said device.

31. The device of claim 30, wherein the electrical signal is transmitted wirelessly.

32. A filter assembly comprising:
a filter element;
a bowl having a base at a bottom thereof and configured to house said filter element; and
a missing-filter-element indicator coupled to said bowl's base, said indicator comprising:
(a) a housing having a top end, a bottom end, a first passage extending axially downwards from the housing's top end, and a second passage extending axially upwards from the housing's bottom end;
(b) a piston slidably disposed through said top end of the housing, the piston being configured to slide through said first passage and having an upper end for selectively receiving the filter element thereon;
(c) a first magnet disposed axially adjacent said piston and within said first passage;
(d) a button slidably disposed through said bottom end of the indicator housing and configured to slide through said second passage; and
(e) a second magnet disposed axially adjacent said button.

33. The filter assembly of claim 32, wherein the first and second magnets are pin magnets that face one another with respective opposite poles such that, when the filter element rests on the piston's upper end, the piston and first magnet slide axially inside said first passage, thus attracting the second magnet and button axially inside said second passage, and when the filter element is removed, the piston moves axially outwardly through the indicator housing's top end and the button pops out through the indicator housing's bottom end, thereby indicating that the filter element is missing.

34. The filter assembly of claim 32, wherein the indicator further includes a first biasing means configured to urge the piston out through the indicator housing's top end and a second biasing means configured to urge the button out through the indicator housing's bottom end when the filter element is missing.

35. The filter assembly of claim 34, wherein said first biasing means is a coil spring disposed axially below said upper end of the piston, and said second biasing means is a coil spring disposed axially within said second passage.

36. The filter assembly of claim 32, wherein the bowl's base defines a central opening therethrough, the bowl includes an annular wall that is unitary with said base and extends vertically downwards from said opening, and said annular wall is configured to selectively receive said indicator therein such that, when installed, the indicator housing's bottom end is substantially flush with said annular wall's bottom end.

37. The filter assembly of claim 36, wherein, when the filter element rests on the piston's upper end, the button's bottom end is configured to be substantially flush with said annular wall's bottom end, and when the filter element is missing, the button's bottom end is configured to pop out beyond the annular wall's bottom end, thereby indicating a missing filter element.

38. The filter assembly of claim 36, further including an annular seal disposed between a radially-outer surface of the indicator housing and a radially-inner surface of the annular wall.

39. The filter assembly of claim 36, wherein the piston and button are generally cylindrical, and the indicator further includes an upper annular cap disposed between a radially-outer surface of the piston and a wall of the first passage, and a lower annular cap disposed between a radially-outer surface of the button and a wall of the second passage.

40. The filter assembly of claim 32, further including means for providing an electrical signal to indicate a missing filter element.

41. The filter assembly of claim 40, wherein said means includes a member selected from the group consisting of a micro-switch, a Hall Effect sensor, and a Reed switch.

42. The filter assembly of claim 40, wherein said electrical signal is transmitted to provide a missing-filter-element indication at a location remote from said indicator.

43. The filter assembly of claim 42, wherein the electrical signal is transmitted wirelessly.

44. A filter assembly comprising:
a filter element;
a bowl having a base at a bottom thereof and configured to house said filter element; and
a missing-filter-element indicator coupled to said bowl's base, said indicator comprising:
(a) a cylindrical housing having a top end, a bottom end, a first passage extending axially inwards from said top end and having a semi-closed base that defines a central opening therethrough, and a second passage having a first annular wall that extends axially from said opening to a solid base adjacent said housing's bottom end;
(b) a piston slidably disposed through said top end of the housing, the piston being configured to move axially through said first passage and having an upper end for selectively receiving the filter element thereon;
(c) a first magnet disposed axially adjacent said piston and configured to move through said second passage;
(d) a button slidably disposed through said bottom end of the indicator housing; and
(e) a second magnet disposed adjacent said button.

45. The filter assembly of claim 44, wherein the annular wall of the second passage and a radially-inner surface of the indicator housing below said semi-closed base define an annular compartment therebetween, and said button is configured to slide axially through said annular compartment.

46. The filter assembly of claim 45, wherein the indicator further includes an upper annular cap disposed between a radially-outer surface of the piston and a wall of the first passage, and a lower annular cap disposed between a radially-outer surface of the button and a wall of the annular compartment.

47. The filter assembly of claim 45, wherein the piston and button are configured such that, when the filter element rests on the piston's upper end, the piston urges the first magnet axially through said second passage, thus attracting the second magnet and button axially inside said annular compartment, and when the filter element is removed, the piston moves axially outwardly through the indicator housing's top end and the button pops out through the indicator housing's bottom end, thereby indicating that the filter element is missing.

48. The filter assembly of claim 47, wherein the first magnet is a pin magnet and the second magnet is a ring magnet that is disposed such that, when the pin magnet moves towards the indicator housing's top end, the first and second magnets repulse one another, thereby causing the button to pop out through said housing's bottom end.

49. The filter assembly of claim 44, wherein the indicator further includes a biasing means disposed axially below said upper end of the piston, the biasing means being configured to urge the piston out through the indicator housing's top end.

50. The filter assembly of claim 44, wherein the bowl's base defines a central opening therethrough, the bowl includes a second annular wall that is unitary with said base and extends vertically downwards from said opening, and said second annular wall is configured to selectively receive said indicator therein such that, when installed, the indicator housing's bottom end is substantially flush with said second annular wall's bottom end.

51. The filter assembly of claim 50, wherein, when the filter element rests on the piston's upper end, the button's bottom end is configured to be substantially flush with said second annular wall's bottom end, and when the filter element is missing, the button's bottom end is configured to pop out beyond the second annular wall's bottom end, thereby indicating a missing filter element.

52. The filter assembly of claim 50, further including an annular seal disposed between a radially-outer surface of the indicator housing and a radially-inner surface of the second annular wall.

53. The filter assembly of claim 44, further including means for providing an electrical signal to indicate a missing filter element.

54. The filter assembly of claim 53, wherein said means includes a member selected from the group consisting of a micro-switch, a Hall Effect sensor, and a Reed switch.

55. The filter assembly of claim 53, wherein said electrical signal is transmitted to provide a missing-filter-element indication at a location remote from said indicator.

56. The filter assembly of claim 55, wherein the electrical signal is transmitted wirelessly.
